(19) United States
(12) Patent Application Publication
(10) Pub. No.: US 2026/0284788 A1
(43) Pub. Date: Sep. 24, 2026

(54) WELDING DEVICE

(71) Applicant: KABUSHIKI KAISHA TOSHIBA, Kawasaki-shi (JP)

(72) Inventor: Tetsuo SAKAI, Taito (JP)

(73) Assignee: KABUSHIKI KAISHA TOSHIBA, Kawasaki-shi (JP)

(21) Appl. No.: 19/558,849

(22) Filed: Mar. 6, 2026

(30) Foreign Application Priority Data
Mar. 24, 2025 (JP) 2025-049090

(51) Int. Cl. B23K 26/22; B23K 26/064; B23K 26/067

(52) U.S. Cl. CPC B23K 26/22; B23K 26/0648; B23K 26/0652; B23K 26/067

(57) ABSTRACT

According to an embodiment of the invention, a welding device includes a light source, a collimator lens, a first optical element, a second optical element, and a focusing lens. The light source is configured to emit a beam in a first direction. The collimator lens is configured to transmit the beam. The first optical element is configured to separate the beam into a first beam and a second beam. The second optical element is configured to transmit the first beam. The focusing lens is configured to irradiate a workpiece to be welded. The first optical element is located between the collimator lens and the second optical element. The second optical element is located between the first optical element and the focusing lens. The workpiece is irradiated with the first beam and the second beam simultaneously.

### CROSS-REFERENCE TO RELATED APPLICATIONS

This application is based upon and claims the benefit of priority from Japanese Patent Application No. 2025-049090, filed on Mar. 24, 2025; the entire contents of which are incorporated herein by reference.

### FIELD

Embodiments of the invention relate to a welding device.

### BACKGROUND

For example, there is a welding device for performing welding on a workpiece. It is desirable for the welding device to improve productivity.

### BRIEF DESCRIPTION OF THE DRAWINGS

FIG. 1 is a schematic diagram showing an example of a welding device according to an embodiment;

FIG. 2 is a diagram showing an irradiation area of a beam from a light source in the welding device according to the embodiment;

FIG. 3 is a diagram showing irradiation areas of a first beam and a second beam in the welding device according to the embodiment;

FIG. 4 is a diagram showing irradiation areas of the first beam and the second beam in the welding device according to the embodiment;

FIG. 5 is a diagram showing irradiation areas of the first beam and the second beam in the welding device according to the embodiment;

FIG. 6 is a perspective view showing an example of a workpiece for the welding device according to the embodiment;

FIG. 7 is an enlarged perspective view of a part of FIG. 6;

FIG. 8 is a schematic diagram showing an example of the welding device according to the embodiment;

FIG. 9 is a schematic diagram showing an example of a device capable of observing a pair of rectangular wires; and

FIG. 10 is a schematic diagram showing an example of a feedback system.

### DETAILED DESCRIPTION

According to an embodiment of the invention, a welding device includes a light source, a collimator lens, a first optical element, a second optical element, and a focusing lens. The light source is configured to emit a beam in a first direction. The collimator lens is configured to transmit the beam. The first optical element is configured to separate the beam into a first beam and a second beam. The second optical element is configured to transmit the first beam. The focusing lens is configured to irradiate a workpiece to be welded. The first optical element is located between the collimator lens and the second optical element. The second optical element is located between the first optical element and the focusing lens. The workpiece is irradiated with the first beam and the second beam simultaneously.

Hereinafter, embodiments of the invention will be described with reference to the drawings.

The drawings are schematic or conceptual, and the relationship between the thickness and width of each portion, the proportions of sizes among portions, and the like are not necessarily the same as the actual values. Even the dimensions and proportion of the same portion may be illustrated differently depending on the drawing.

In the specification and drawings, components similar to those described in regard to a drawing thereinabove are marked with like reference numerals, and a detailed description is omitted as appropriate.

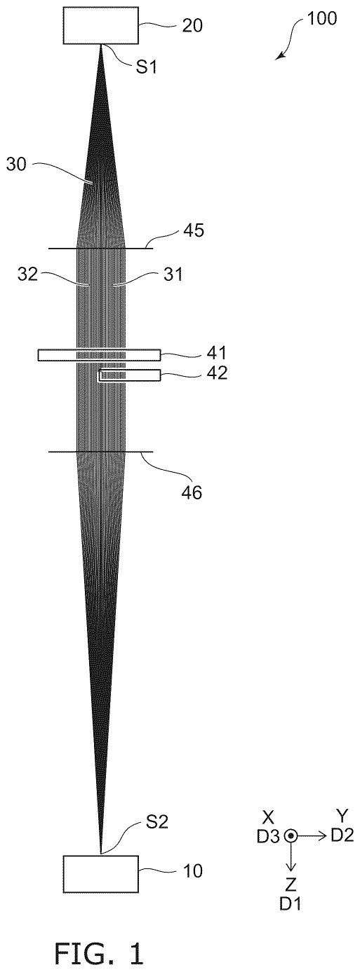

FIG. 1 is a schematic diagram showing an example of a welding device according to an embodiment.

As shown in FIG. 1, a welding device 100 according to the embodiment includes a light source 20, a collimator lens 45, a first optical element 41, a second optical element 42, and a focusing lens 46.

The light source 20 emits a beam 30 in a first direction D1. The collimator lens 45 transmits the beam 30. The first optical element 41 separates the beam 30 into a first beam 31 and a second beam 32. The second optical element 42 transmits the first beam 31. The focusing lens 46 irradiates the workpiece 10 to be welded, with the first beam 31 and the second beam 32. The beam 30 is a bundle of “particles” or “waves” traveling in a substantially straight line. The beam 30 may be a laser. The welding may be laser welding.

The first optical element 41 is located between the collimator lens 45 and the second optical element 42. The second optical element 42 is located between the first optical element 41 and the focusing lens 46. The workpiece 10 is irradiated with the first beam 31 and the second beam 32 simultaneously.

The direction of the workpiece 10 from the light source 20 is defined as the first direction D1. The first direction D1 is defined as a Z-axis. One direction perpendicular to the Z-axis direction is defined as an X-axis direction. A direction perpendicular to the X-axis direction and the Z-axis direction is defined as a Y-axis direction. The Y-axis direction may be, for example, a second direction D2. The X-axis direction may be, for example, a third direction D3.

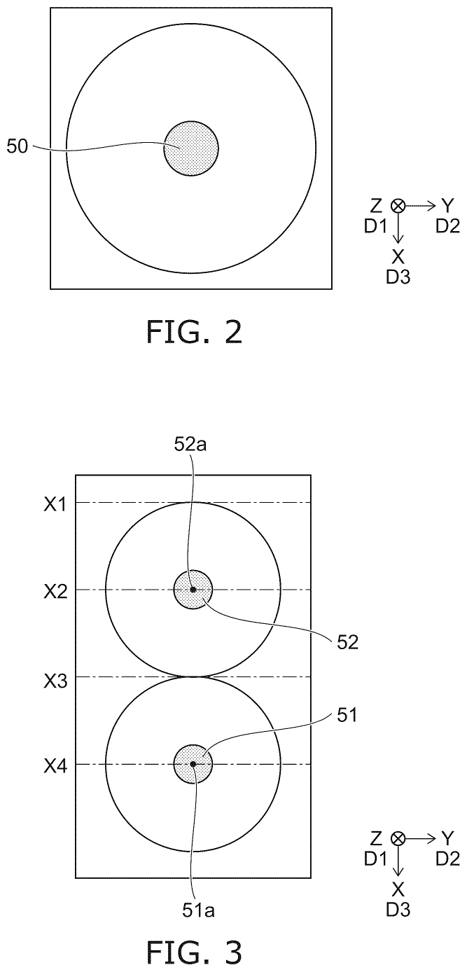

FIG. 2 is a diagram showing an irradiation area of the beam from the light source in the welding device according to the embodiment. FIG. 2 shows an irradiation area in a first spot in FIG. 1.

FIG. 3 shows irradiation areas of the first beam and the second beam in the welding device according to the embodiment. FIG. 3 shows irradiation areas in a second spot in FIG. 1.

As shown in FIG. 2, in a first spot S1 before the beam 30 passes through the collimator lens 45, an irradiation area 50 of the beam 30 is one point. After passing through the first optical lens 41, the beam 30 is separated into the first beam 31 and the second beam 32. In a second spot S2 after the first beam 31 passes through the first optical element 41, the second optical element 42, and the focusing lens 46, the first beam 31 results in an irradiation area 51 of the first beam 31 as shown in FIG. 3. The second optical element 42 controls the position of the first beam 31. In the second spot S2 after the second beam 32 passes through the first optical element 41 and the focusing lens 46, the second beam 32 results in an irradiation area 52 of the second beam 32 as shown in FIG. 3.

As shown in FIG. 3, a first center position 51a of the first beam 31 to the workpiece 10 is apart from a second center position 52a of the second beam 32 to the workpiece 10 in the third direction D3. In the second spot S2, two points of the first beam 31 and the second beam 32 are irradiated simultaneously. As a result of the two points of the first beam 31 and the second beam 32 being irradiated simultaneously, welding is performed.

A reference example in which simultaneous irradiation of the workpiece 10 with the first beam 31 and the second beam 32 is not performed is considered. In this reference example, the number of welding spots increases, which results in an increase in the tact time. The number of welding spots may increase by a factor of two or more. When the workpiece 10 includes a covered wire, the covered wire is affected by the heat. When the workpiece 10 is a pair of rectangular wires, strong welding is required for the space depending on the product. Further, when the workpiece 10 is a pair of rectangular wires of a high-voltage motor, the covered wire including the metal wire is large, and the space between the pair of rectangular wires increases accordingly.

In the welding device 100 according to the embodiment, the workpiece 10 is irradiated with the first beam 31 and the second beam 32 simultaneously. Accordingly, the tact time is reduced and productivity can be improved. The effect of the heat on the covered wire can be reduced. As a result, welding can be stabilized. Welding can be stabilized by an increase in the margin for the space described above. Spatter during welding can be reduced.

The first optical element 41 may be, for example, flat glass or a prism. The first optical element 41 may be, for example, a convex prism. The second optical element 42 may be a prism.

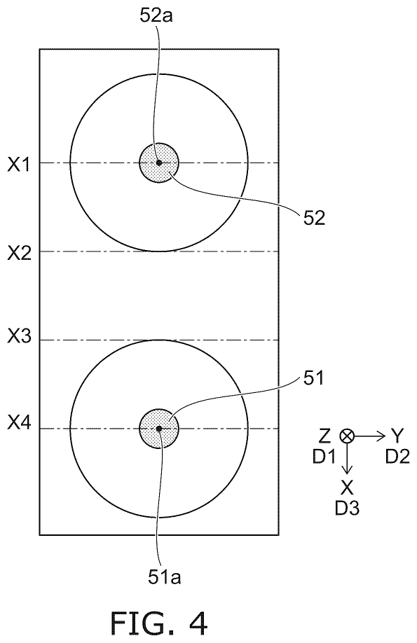

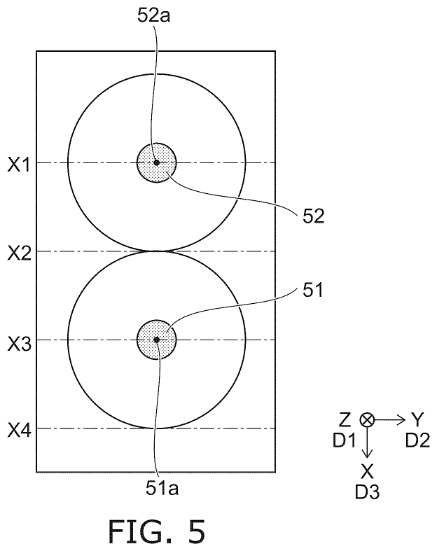

FIG. 4 and FIG. 5 are diagrams showing irradiation areas of the first beam and the second beam in the welding device according to the embodiment. FIG. 4 and FIG. 5 show irradiation areas in the second spot in FIG. 1.

The first center position 51a of the first beam 31 to the workpiece 10 may be adjusted by the angles of the prisms of the first optical element 41 and the second optical element 42. The second center position 52a of the second beam 32 to the workpiece 10 may be adjusted by the angles of the prisms of the first optical element 41. The surfaces of the first optical element 41 and the second optical element 42 on the focusing lens 46 side are inclined with respect to the first direction D1. When the angles of the first optical element 41 and the second optical element 42 are adjusted, the first beam 31 and the second beam 32 can be moved in the third direction D3 as shown in FIG. 4 and FIG. 5.

Regarding the irradiation area 52 of the second beam 32 shown in FIG. 4, the second center position 52a of the irradiation area 52 of the second beam 32 is shifted from X2 to X1 as compared with the irradiation area 52 of the second beam 32 shown in FIG. 3. This can be adjusted by the angles of the prisms of the first optical element 41.

Regarding the irradiation area 51 of the first beam 31 shown in FIG. 5, the first center position 51a of the irradiation area 51 of the first beam 31 is shifted from X4 to X3 as compared with the irradiation area 51 of the first beam 31 shown in FIG. 3. This can be adjusted by the angle of the prism of the first optical element 41 and the second optical element 42.

The output of the first beam 31 and the output of the second beam 32, with which the workpiece 10 is irradiated, may be the same.

The first center position 51a of the first beam 31 to the workpiece 10 and the second center position 52a of the second beam 32 to the workpiece 10 may be aligned in the third direction D3 crossing the first direction D1.

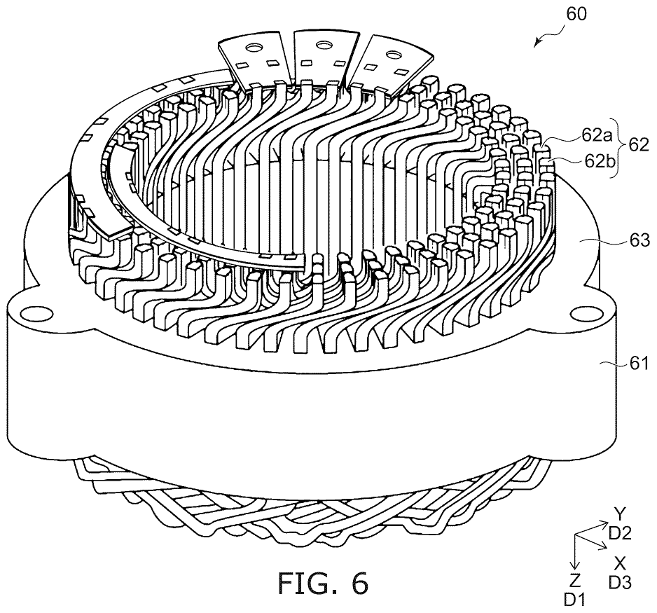

FIG. 6 is a perspective view showing an example of the workpiece for the welding device 100 according to the embodiment. FIG. 6 shows the whole of a stator.

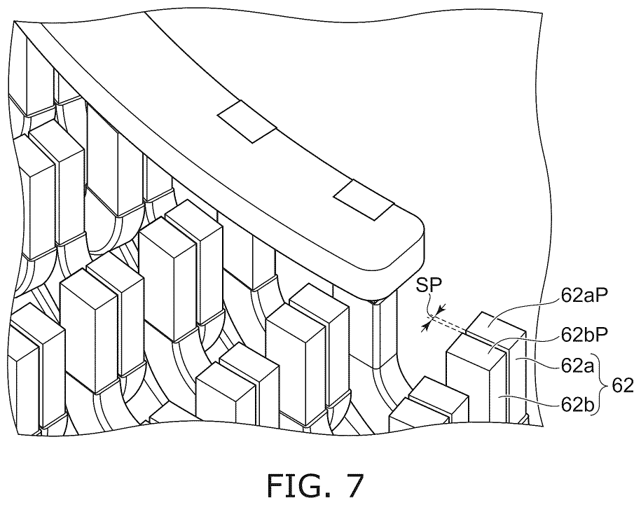

FIG. 7 is an enlarged perspective view of a part of FIG. 6.

As shown in FIG. 6, a stator 60 has a cylindrical form and includes a core 61 and a coil 62. The core 61 is constituted by a plurality of annular magnetic members laminated in the Z-direction. The magnetic members are formed of, for example, electromagnetic steel sheets (silicon steel sheets).

The coil 62 is constituted by a plurality of segments. The plurality of segments include a first segment 62a and a second segment 62b. The segments include a metal wire and an insulating covering. The insulating covering covers the outer surface of the metal wire. However, no insulating covering is provided in the vicinity of the end portions on both sides of the metal wire, and the metal wire is exposed. The insulating covering is formed of, for example, an insulating material, such as enamel.

The metal wire is formed of a material having a high conductivity. As the metal wire, for example, a rectangular wire is used. The rectangular wire is a linear member having a rectangular cross section. The size of the cross section of the rectangular wire is, for example, about 1 mm to 4 mm. For the metal wire, pure copper or a material containing copper as a main component can be used.

The workpiece 10 for the welding device 100 according to the embodiment may include a pair of rectangular wires (rectangular wires) as shown in FIG. 6 and FIG. 7. The pair of rectangular wires are two adjacent rectangular wires and are the first segment 62a and the second segment 62b shown in FIG. 6 and FIG. 7.

The rectangular wires may include a first part and a second part. The first part corresponds to, for example, a tip 62aP of the first segment 62a shown in FIG. 7. The second part corresponds to, for example, a tip 62bP of the second segment 62b shown in FIG. 7. The first part is irradiated with the first beam 31. The second part is irradiated with the second beam 32. The first part is irradiated with the first beam 31 and the second part is irradiated with the second beam 32, and the first part and the second part are welded accordingly. As a result, the first part and the second part are connected by welding.

As shown in FIG. 7, there is a space SP between the first segment 62a and the second segment 62b. Since the welding device 100 irradiates the first part with the first beam 31 and irradiates the second part with the second beam 32 simultaneously, the margin for the space SP is increased, which can stabilize the welding.

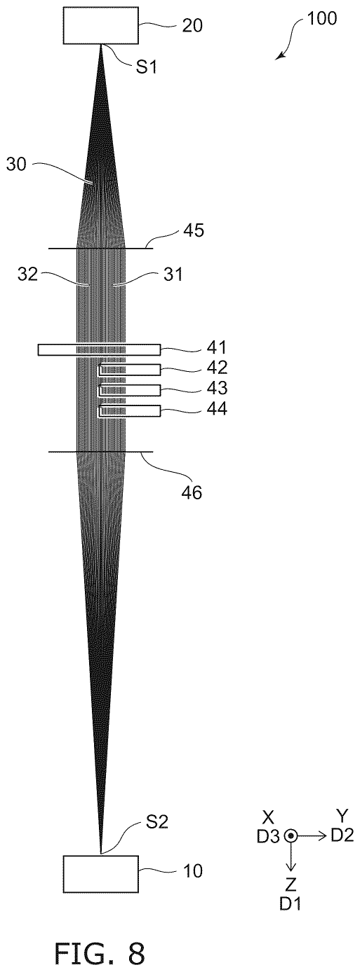

FIG. 8 is a schematic diagram showing an example of the welding device according to the embodiment. In FIG. 8, optical elements are added to the welding device shown in FIG. 1.

As shown in FIG. 8, the welding device 100 may further include a third optical element 43 and a fourth optical element 44. The third optical element 43 and the fourth optical element 44 may be, for example, prisms. The third optical element 43 is located between the second optical element 42 and the fourth optical element 44. The fourth optical element 44 is located between the third optical element 43 and the focusing lens 46.

The third optical element 43 allows the first center position 51a of the first beam 31 to move in the third direction D3. The fourth optical element 44 allows the first center position 51a of the first beam 31 to move in the third direction D3. The distance between the first center position 51a of the first beam 31 and the second center position 52a of the second beam 32 can be adjusted by the third optical element 43. The distance between the first center position 51a of the first beam 31 and the second center position 52a of the second beam 32 can be adjusted by the fourth optical element 44. Since such adjustments can be made, the space SP between the pair of rectangular wires can be, whether it is large or small, supported.

The moving distance in the third direction D3 is adjusted by the angles of the prisms of the third optical element 43 and the fourth optical element 44. The angle of the prism of the third optical element 43 may be different from the angles of the prism of the second optical element 42 and the prism of the fourth optical element 44. The angle of the prism of the fourth optical element 44 may be different from the angles of the prism of the second optical element 42 and the prism of the third optical element 43. The different angles of the prisms enable a fine adjustment of the movement in the third direction D3.

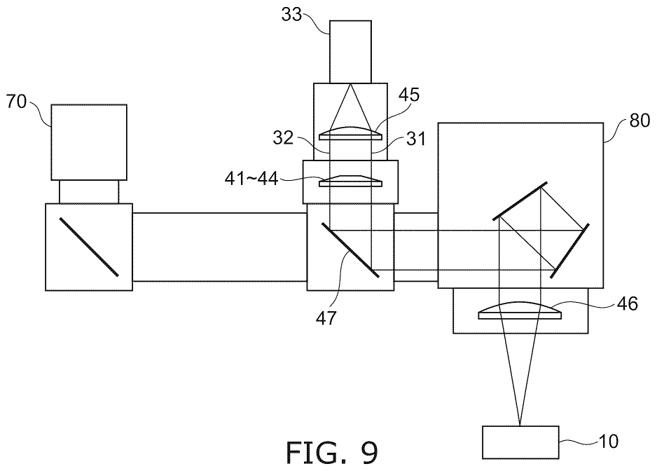

FIG. 9 is a schematic diagram showing an example of a device capable of observing the pair of rectangular wires.

The welding device 100 may include a camera 70 for observing the pair of rectangular wires. The camera 70 observes the distance (space SP) between the first segment 62a and the second segment 62b. The camera 70 observes the position of the center of gravity of the first segment 62a and that of the second segment 62b. The beam 30 passes through the collimator lens 45 and the first to fourth optical elements 41 to 44 through an optical fiber 33, is reflected by a bending mirror 47, is controlled into a certain direction by a galvanometer scanner 80, and passes through the focusing lens 46 to irradiate the workpiece 10.

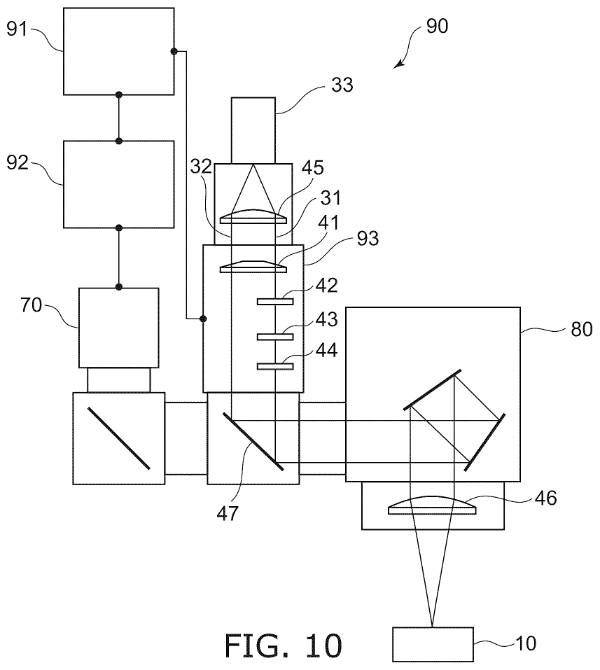

FIG. 10 is a schematic diagram showing an example of a feedback system.

The welding device 100 may include a feedback system 90 for providing feedback on the positions of the first beam 31 and the second beam 32, based on information about the distance between the first segment 62a and the second segment 62b and the center of gravity thereof. The feedback system 90 includes a control device 91 and a personal computer 92. The control device 91 communicates with the personal computer 92. The personal computer 92 communicates with the camera 70. When the positions of the first beam 31 and the second beam 32 deviate from the first segment 62a and the second segment 62b, the feedback system 90 provides a notification by, for example, an alarm.

The feedback system 90 may include a lens drive mechanism 93 that automatically controls the positions of the first to fourth optical elements 41 to 44.

The lens drive mechanism 93 moves the positions of the first optical element 41 and the second optical element 42. The lens drive mechanism 93 may automatically control the positions of the first to fourth optical elements 41 to 44 based on feedback from the feedback system 90. Specifically, the pair of rectangular wires, which is a processing point, is observed with the camera 70. Then, image processing is performed by software of the personal computer 92, and the disposition of the target segments is recognized. Then, calculation is performed by the software, and the positions of the center of gravity of the segments, the value of the space SP, and the irradiation position of the beam 30 are grasped. Then, a control signal is transmitted from the personal computer 92 to the control device 91, and the lens drive mechanism 93 drives the first to fourth optical elements 41 to 44. Accordingly, the lens drive mechanism 93 of the feedback system 90 controls the first to fourth optical elements 41 to 44, and the irradiation positions of the first beam 31 and the second beam 32 are controlled.

Hereinabove, embodiments of the invention have been described with reference to specific examples. However, the invention is not limited to these specific examples. For example, one skilled in the art may similarly practice the invention by appropriately selecting specific configurations of components included in the welding device, such as the optical elements, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all welding devices practicable by an appropriate design modification by one skilled in the art based on the welding devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A welding device comprising:
a light source configured to emit a beam in a first direction;
a collimator lens configured to transmit the beam;
a first optical element configured to separate the beam into first beam and the second beam;
a second optical element configured to transmit the first beam; and
a focusing lens configured to irradiate a workpiece to be welded,
the first optical element being located between the collimator lens and the second optical element,
the second optical element being located between the first optical element and the focusing lens,
the workpiece being irradiated with the first beam and the second beam simultaneously.

2. The welding device according to claim 1, wherein
the first optical element is flat glass or a prism, and
the second optical element is a prism.

3. The welding device according to claim 1, wherein
the workpiece includes a first part and a second part,
the first part is irradiated with the first beam, and
the second part is irradiated with the second beam.

4. The welding device according to claim 1, wherein an output of the first beam and an output of the second beam with which the workpiece is irradiated are the same.

5. The welding device according to claim 1, wherein a first center position of the first beam to the workpiece is apart from a second center position of the second beam to the workpiece in a third direction crossing the first direction.

6. The welding device according to claim 1, wherein a first center position of the first beam to the workpiece and a second center position of the second beam to the workpiece are aligned in a third direction crossing the first direction.

7. The welding device according to claim 1, further comprising:
a camera configured to observe a distance between a first segment and a second segment, and a center of gravity of the first segment and a center of gravity of the second segment.

8. The welding device according to claim 7, further comprising:
a feedback system configured to provide feedback on a position of the first beam and a position of the second beam, based on information about the distance and the centers of gravity.

9. The welding device according to claim 8, further comprising:
a lens drive mechanism configured to automatically control positions of the first optical element and the second optical element,
the lens drive mechanism being configured to automatically control the positions of the first optical element and the second optical element, based on the feedback from the feedback system.
